(19) United States
(12) Patent Application Publication
(10) Pub. No.: US 2018/0142569 A1
(43) Pub. Date: May 24, 2018

(54) INLET GUIDE WHEEL FOR A TURBO ENGINE

(71) Applicant: Rolls-Royce Deutschland Ltd & Co KG, Blankenfelde-Mahlow (DE)

(72) Inventor: Frank HEINICHEN, Berlin (DE)

(21) Appl. No.: 15/812,667

(22) Filed: Nov. 14, 2017

(30) Foreign Application Priority Data
Nov. 24, 2016 (DE) 10 2016 122 696.3

(51) Int. Cl. F01D 17/14

(52) U.S. Cl. CPC F01D 17/148; F05D 2240/122; F05D 2240/121

(57) ABSTRACT

An embodiment of the invention relates to an inlet guide wheel for a turbo engine with a plurality of guide vanes that radially extend inside a flow channel of the turbo engine, and that respectively comprise: a first, radially outer aerofoil that comprises a radially inner end, and a second, radially inner aerofoil that comprises a radially outer end, wherein the first aerofoil and/or the second aerofoil is embodied in a rotatable manner. It is provided that the first aerofoil and the second aerofoil are separated by a tip shroud which at least partially covers both the radially inner end of the first aerofoil and the radially outer end of the second aerofoil.

### REFERENCE TO RELATED APPLICATION

This application claims priority to German Patent Application No. 10 2016 122 696.3 filed on Nov. 24, 2016, the entirety of which is incorporated by reference herein.

### BACKGROUND

The invention relates to an inlet guide wheel for a turbo engine having a plurality of inlet guide vanes.

Compressors of aircraft engines are designed for a certain design speed. In the partial load range, i.e. at rotational speeds of less than the design speed, there is the danger of local flow separation occurring at the rotor blades of the compressor. For reducing the risk of flow separation in the partial load range, it is known to arrange a stator with adjustable stator blades in front of the first rotor of the compressor. Such a stator is referred to as an inlet guide wheel or pre-guiding wheel. Inlet guide wheels with a variable stagger angle improve the working range of a compressor.

However, in the partial load range there is the problem that the axial velocity is reduced in the first rotor arranged behind the inlet guide wheel due to the swirl that is applied to the working medium by the inlet guide wheel. This particularly applies to areas of the rotor blades that are located further radially outside. At this position, there is an increased risk that a flow separation occurs and that high-frequency vibrations are generated. Thus, it is advantageous to embody an inlet guide wheel in such a manner that it provides the working medium with a lower swirl in the radially outer area, so that the axial velocity is increased in the tip area of the rotor blades of the downstream rotor.

US 2010/0260591 A1 describes a compressor inlet guide vane that consists of two, respectively adjustable blade areas that are radially spaced apart from each other.

EP 2 017 434 B1 describes a compressor inlet guide vane system that has guide vanes which are formed in a flexible manner in the axially rear area. Here, one embodiment provides that a radially outer rear area of the guide vanes is formed so as to be fixedly attached, and a radially inner rear area of the guide vanes is formed in a flexible manner, wherein the two areas can be rotated independently of each other about a longitudinal axis through separate actuation means.

There is a need for an inlet guide wheel for a turbo engine with improved aerodynamic characteristics.

### SUMMARY

According to an aspect of the invention an inlet guide wheel for a turbo engine is provided that has a plurality of guide vanes which extend radially in the flow channel of the turbo engine in a circumferentially distributed manner. The guide vanes respectively have a first, radially outer aerofoil and a second, radially inner aerofoil. The first, radially outer aerofoil comprises a radially inner end, and the second, radially inner aerofoil comprises a radially outer end. At least one of the aerofoils is embodied in a rotatable manner.

It is provided that the first aerofoil and the second aerofoil are separated by a tip shroud which respectively at least partially covers the radially inner end of the first aerofoil and the radially outer end of the second aerofoil.

Thus, an aspect of the invention is based on the idea of improving the aerodynamic characteristics of a radially divided inlet guide wheel that is provided with radially inner and radially outer aerofoils by providing a tip shroud that covers the adjacent ends of the aerofoils which are projecting into the flow channel and in this manner, for one thing, prevents a flow leakage between the adjacent ends of the aerofoils and, for another thing, prevents vortices at these ends of the aerofoils. At that, the tip shroud in a sense covers the ends of the radially inner aerofoils and the radially outer aerofoils that are projecting into the flow channel.

An aspect of the invention provides an improved partial-load inflow in the blade tip area of the rotor blades of the first rotor of a turbo engine that is arranged downstream of the inlet guide wheel. In this manner, it facilitates an increase in the stability of a turbo engine under partial-load conditions. It can be used with inlet guide wheels of any desired turbo engine, in particular with inlet guide wheels of axial compressors, radial compressors, and turbines in aircraft engines as well as gas turbines.

According to one embodiment of the invention, it is provided that the first aerofoil is locally affixed and the second aerofoil is rotatable relative to the first aerofoil. A rotatability or adjustability of the stagger angle is thus provided only for the second, radially inner aerofoil. In this embodiment, the solution according to the invention in particular prevents a flow leakage as it would occur between the adjacent aerofoils projecting into the flow channel if no tip shroud were present, in particular in the event that the radially outer aerofoil and the radially inner aerofoil have different stagger angles.

However, it is to be understood that in principle the invention can also be realized with inlet guide wheels in which both the first, radially outer aerofoil and the second, radially inner aerofoil are formed so as to be rotatable, and namely in a manner independently of each other, or are adjustable with respect to their stagger angle, and further it can principally also be realized with inlet guide wheels in which only the first, radially outer aerofoil is adjustable with respect to its stagger angle.

In a further embodiment of the invention it is provided that the tip shroud is connected to the first aerofoil or is integral with the same, i.e. is formed in one piece with the same. In particular, it can be provided that the tip shroud, the first aerofoil, and an outer tip shroud with which the first aerofoil can be arranged in an outer housing structure are integrally formed. The integral embodiments prevents any gap between the tip shroud and the first aerofoil. At the same time, the tip shroud covers the free end of the second, radially inner aerofoil.

Alternatively, the tip shroud and the first aerofoil can be assembled of individual components. Taken by itself, the tip shroud can also consist of one part, or can be comprised of multiple parts.

According to a further embodiment of the invention, the second aerofoil is connected to an outer spindle in a torque-proof manner for providing a rotatability. The spindle can be operated from outside the inlet guide wheel. Here, it is provided that the outer spindle is guided inside a spindle passage of the first aerofoil, which may for example be embodied as a bore. Thus, the first, radially outer aerofoil serves as a cover for the spindle which is necessary for providing the adjustability of the second aerofoil.

Here, it can be provided that the spindle axis, which coincides with the rotational axis of the second aerofoils, extends in the radial direction. Likewise, it can be provided that the spindle axis extends so as to be tilted with respect to the radial direction. The spindle axis for the rotation of the second, radially inner aerofoil can thus be embodied either in a completely radial direction or in a tilted manner. The tilted alignment can have advantages with respect to the integration of a rotary plate in the tip shroud, and with respect to the formation of a cut back at the trailing edge of the second aerofoil, as will be described in the following.

The compressor rotor 20 is described in a cylindrical coordinate system having the coordinates x, r and φ. Here, x indicates the axial direction, r indicates the radial direction, and φ indicates the angle in the circumferential direction. Here, the axial direction is identical to the machine axis of a gas turbine in which the turbo engine with the inlet guide wheel according to the invention is arranged. Beginning at the x-axis, the radial direction points radially outwards. Here, terms such as “in front”, “behind”, “frontal” and “rear” refer to the axial direction, and terms such as “outer” or “inner” refer to the radial direction.

In a further embodiment of the invention it is provided that the outer spindle, which serves for providing the adjustability of the second, radially inner aerofoil, has a spindle end that projects at the inner side from the first aerofoil and that is arranged inside the tip shroud and mounted in the same. Thus, the tip shroud receives the end of the spindle.

Further, it can be provided that the second, radially inner aerofoil is connected, at its radially outer end, to an outer circular platform, or that it forms such an outer circular platform, wherein the outer platform is arranged inside the tip shroud and is mounted in the same. The circular platform in particular forms a rotary plate that is connected to the spindle and serves to provide for the rotatability of the second aerofoil.

Thus, it is provided according to one embodiment of the invention that, for one thing, the tip shroud, at its radially outer side, has a circular hole for receiving and mounting the spindle end of the outer spindle, and, radially adjoining thereto and on its radially inner side, has a circular hole for receiving and mounting the outer platform. The spindle end and the outer platform are both arranged and mounted inside the tip shroud.

According to a further embodiment, the second aerofoil has an inner circular platform and an inner spindle at its radially inner end. Here, the inner circular platform also forms a rotary plate for adjusting the second, radially inner aerofoil. The rotary plate and the inner spindle are arranged and mounted in an inner tip shroud of the inlet guide wheel. Here, together with the inner tip shroud, the circular platform forms the radially inner boundary of the flow channel through the inlet guide wheel. The inner spindle cannot be actuated from the outside and serves only as a bearing. The aerofoil is adjusted only by means of the outer spindle.

According to one embodiment of the invention, it is provided that the tip shroud covers the radially inner end of the first aerofoil and the radially outer end of the second aerofoil in such a manner that, at least in the area of the leading edge of the aerofoils, no gap is formed between the radially inner end of the first blade and the tip shroud, and no gap is formed between the radially outer end of the second blade and the tip shroud. Thus, at least at the leading edge and adjacent to the leading edge of the aerofoils, free blade ends and resulting vortices are avoided through the tip shroud.

In one embodiment variant of the invention, it is provided that the second aerofoil has a cut back in the area of its trailing edge adjoining the tip shroud, namely in such a manner that it forms a gap towards the tip shroud in the area of its trailing edge. In this manner, a rotatability of the second, radially inner aerofoil relative to the tip shroud is facilitated without any danger that the aerofoil collides with the tip shroud at its trailing edge.

In a corresponding manner, it can be provided that the second aerofoil also has a cut back in the area of its trailing edge adjoining the radially inner flow channel boundary, namely in such a manner that it forms a gap towards the radially inner flow channel boundary in the area of its trailing edge.

According to one embodiment variant, the first aerofoils and the second aerofoils are formed in such a manner, and the second aerofoils can be adjusted in the partial load range in such a manner with respect to the stagger angle that the second aerofoils cause a stronger swirl to be applied to the passing work fluid than the first aerofoils. In this manner, it is achieved that the rotor blades of a rotor that is arranged downstream of the inlet guide wheel are impacted by the flow in the radially outer area with a higher axial velocity, whereby the danger of flow separation as well as vibration excitation is reduced.

In one embodiment of the invention, it is provided that the second aerofoils extend in the radial direction across a length which corresponds to at least 50%, in particular to at least 60%, in particular to at least 70% of the total length of the radial extension of the first and second aerofoils. The flow channel, which is formed as an annular space, is radially divided in two flow areas in the area of the inlet guide wheel by the first and second aerofoils, namely a radially inner flow area and a radially outer flow area. In the radially inner flow area, the turbulence swirl that is applied to the work fluid by means of the guide vanes can be adjusted by means of the adjustable second aerofoils. They should extend across at least 50% of the radial extension of the entire aerofoil.

As an element that is arranged inside the flow channel, the tip shroud is embodied in an aerodynamically low-drag manner. Correspondingly, it is provided that it comprises a rounded-off leading edge as well as a rounded-off trailing edge.

According to one embodiment variant, the tip shroud is embodied as a tip shroud ring, separating the first aerofoil and the second aerofoil in all guide vanes of the inlet guide wheel, thus at least partially covering radial ends of the aerofoils that project into the flow channel. The tip shroud ring extends in a circular manner inside the inlet guide wheel, at a radial distance to the radially outer flow channel boundary and at a radial distance to the radially inner flow channel boundary. At that, the tip shroud ring may consist of individual segments that are connected to each other.

However, it is to be understood that the embodiment of the tip shroud as a tip shroud ring is not obligatory. In particular, it can alternatively be provided that respectively one separate tip shroud is assigned to the guide vanes, which respectively have a first, radially outer aerofoil and a second, radially inner aerofoil. In this case, the tip shroud extends in the circumferential direction only to such a degree that it can cover the blade ends projecting into the flow channel. In that case, the tip shroud is formed in a manner similar to a loom shuttle.

The guide vanes of the inlet guide wheel extend inside the flow channel of the turbo engine between a radially outer flow channel boundary and a radially inner flow channel boundary. The radially outer flow channel boundary may for example be formed by a housing appliance that delimits the flow channel through the turbo engine radially outside, with the guide vanes of the inlet guide wheel being attached thereto. For this purpose, it can for example be provided that an outer tip shroud or housing tip shroud connecting the radially outer aerofoils is arranged and fixedly attached inside such a housing appliance. The radially inner flow channel boundary of the turbo engine is for example formed by corresponding ring surfaces of the rotors and stators of the respective compressor or turbine stages, or a rotor drum of the corresponding drive shaft.

The invention further relates to a turbo engine, in particular a compressor that comprises an inlet guide wheel that is embodied according to the invention, wherein the inlet guide wheel is arranged upstream of the first rotor of the turbo engine or compressor.

### BRIEF DESCRIPTION OF THE DRAWINGS

The invention will be explained in more detail on the basis of exemplary embodiments with reference to the accompanying drawings in which:

FIG. 1 shows a simplified schematic sectional view of a turbofan engine in which the present invention can be realized;

FIG. 2 shows, in the meridional section and in a schematic manner, an inlet guide wheel with radially outer and radially inner aerofoils that are separated by a tip shroud, as well as its arrangement in a compressor of an aircraft engine;

FIG. 3 shows, in the meridional section, an exemplary embodiment of an inlet guide wheel that has radially outer and radially inner aerofoils which are separated by a tip shroud;

FIG. 4a shows, in a top view, a radially inner aerofoil according to FIG. 3 and components connected therewith;

FIG. 4b shows, in a lateral view, a radially inner aerofoil according to FIG. 3 and components connected therewith;

FIG. 4c shows, in a bottom view, a radially inner aerofoil according to FIG. 3 and components connected therewith;

FIG. 5a shows, in a top view, a radially outer aerofoil according to FIG. 3;

FIG. 5b shows, in a lateral view, a radially outer aerofoil according to FIG. 3;

FIG. 5c shows, in a bottom view, a radially outer aerofoil according to FIG. 3;

FIG. 6a shows a section through the tip shroud ring of FIG. 3 in a plane perpendicular to the axial direction, corresponding to line A-A of FIG. 6b, wherein a segment of the tip shroud ring is shown that extends over a circumferential angle of 45°;

FIG. 6b shows the tip shroud ring of FIG. 3 in the meridional section;

FIG. 7 shows, in the meridional section, a further exemplary embodiment of an inlet guide wheel that has radially outer and radially inner aerofoils which are separated by a tip shroud, wherein the axis of a spindle for adjusting a radially inner aerofoil extends in a tilted manner with respect to the radial direction.

### DETAILED DESCRIPTION

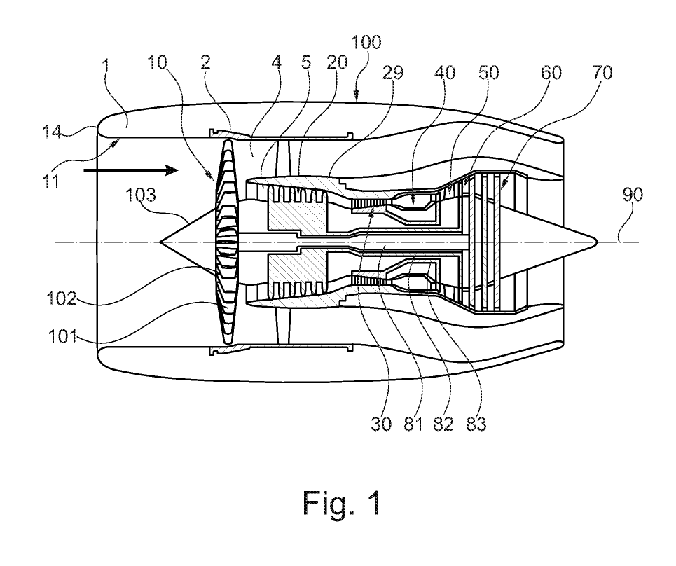

FIG. 1 shows, in a schematic manner, a turbofan engine 100 that has a fan stage with a fan 10 as the low-pressure compressor, a medium-pressure compressor 20, a high-pressure compressor 30, a combustion chamber 40, a high-pressure turbine 50, a medium-pressure turbine 60, and a low-pressure turbine 70.

The medium-pressure compressor 20 and the high-pressure compressor 30 respectively have a plurality of compressor stages that respectively comprise a rotor and a stator. The turbofan engine 100 of FIG. 1 further has three separate shafts, a low-pressure shaft 81 that connects the low-pressure turbine 70 to the fan 10, a medium-pressure shaft 82 that connects the medium-pressure turbine 60 to the medium-pressure compressor 20, and a high-pressure shaft 83 that connects the high-pressure turbine 50 to the high-pressure compressor 30. However, this is to be understood to be merely an example. If, for example, the turbofan engine has no medium-pressure compressor and no medium-pressure turbine, only a low-pressure shaft and a high-pressure shaft would be present.

The turbofan engine 100 has an engine nacelle 1 (also referred to as engine cowl) that comprises an inlet lip 14 and forms an engine inlet 11 at the inner side, supplying inflowing air to the fan 10. The fan 10 has a plurality of fan blades 101 that are connected to a fan disk 102. Here, the annulus of the fan disk 102 forms the radially inner boundary of the flow path through the fan 10. Radially outside, the flow path is delimited by the fan housing 2. Upstream of the fan-disc 102, a nose cone 103 is arranged.

Behind the fan 10, the turbofan engine 100 forms a secondary flow channel 4 and a primary flow channel 5. The primary flow channel 5 leads through the core engine (gas turbine) that comprises the medium-pressure compressor 20, the high-pressure compressor 30, the combustion chamber 40, the high-pressure turbine 50, the medium-pressure turbine 60, and the low-pressure turbine 70. At that, the medium-pressure compressor 20 and the high-pressure compressor 30 are surrounded by a circumferential housing 29 which forms an annulus surface at the internal side, delimitating the primary flow channel 5 radially outside. Radially inside, the primary flow channel 5 is delimitated by corresponding rim surfaces of the rotors and stators of the respective compressor stages, or by the hub or by elements of the corresponding drive shaft connected to the hub.

During operation of the turbofan engine 100, a primary flow flows through the primary flow channel 5, which is also referred to as the main flow channel. The secondary flow channel 4, which is also referred to as the partial-flow channel, sheath flow channel, or bypass channel, guides air sucked in by the fan 10 during operation of the turbofan engine 100 past the core engine.

The described components have a common rotational or machine axis 90. The rotational axis 90 defines an axial direction of the turbofan engine. A radial direction of the turbofan engine extends perpendicularly to the axial direction.

What is regarded in the context of the present invention is a compressor of the aircraft engine that has an inlet guide wheel that is arranged upstream of the first rotor of the compressor. Alternatively, such an inlet guide wheel could be formed in a turbine.

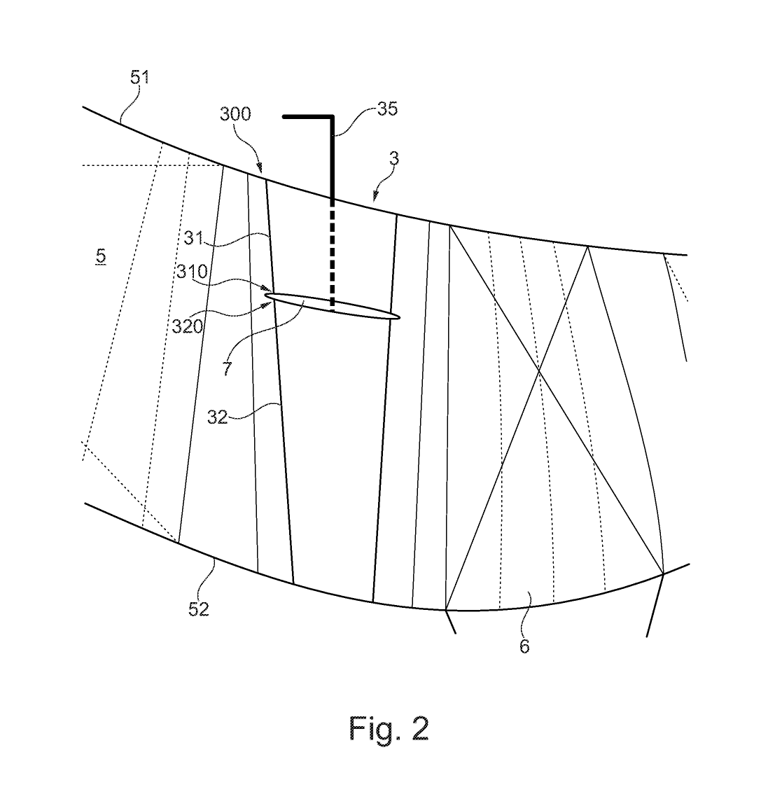

FIG. 2 schematically shows an inlet guide wheel 300 that is constructed according to the principles of the present invention. The inlet guide wheel 300 is arranged inside a flow channel 5 that has a radially outer flow channel boundary 51 and a radially inner flow channel boundary 52. The flow channel 5 is formed as an annular space. It can for example be a primary flow channel corresponding to the primary flow channel 5 of FIG. 1. In the flow channel 5, the inlet guide wheel 300 is arranged in front of the first rotor 6 of a compressor stage of a compressor with respect to the axial direction.

The inlet guide wheel 300 comprises a plurality of guide vanes 3 that respectively have a first, radially outer aerofoil 31 and a second, radially inner aerofoil 32. The radially outer aerofoil 31 is locally affixed and accordingly has a fixed stagger angle. In contrast, the radially inner aerofoil 32 is rotatable about a rotational axis that is defined by the longitudinal axis of a spindle 35, and is thus adjustable with respect to its stagger angle. The spindle 35 can be accessed and adjusted from outside the flow channel 5.

The first, radially outer aerofoil 31 has a radially inner end 310 that projects into the flow channel 5, beginning at the radially outer flow channel boundary 51. The second, radially inner aerofoil 32 has a radially outer end 320 that projects into the flow channel 5, beginning at the radially inner flow channel boundary 52.

The inlet guide wheel 300 further comprises a tip shroud 7 which separates the first aerofoil 31 and the second aerofoil 32. Here, the tip shroud 7 at least partially covers the radially inner end 310 of the first aerofoil 31 and the radially outer end 320 of the second aerofoil 32, in particular in the area of the leading edges of the two aerofoils 31, 32.

Via the spindle 35, the second aerofoil 32 is rotatable and adjustable with respect to its stagger angle relative to the first aerofoil 31. The spindle 35 is guided through the first aerofoil 31, which for that purpose forms a bore, for example. Accordingly, the first aerofoil 31 is formed with a sufficient thickness to be able to receive the spindle 35.

By using a tip shroud 7, any flow leakage between the blade ends 310, 320 as well as vortices at the blade ends 310, 320, which without such a tip shroud are freely projecting into the flow channel 5, are avoided. The tip shroud 7 can further serve for receiving mounting and adjusting elements of the second aerofoil 31, as will be described based on the following Figures by referring to exemplary embodiments.

It is to be understood that, in the meridional section of FIG. 2, only one of the guide vanes 3 of the inlet guide wheel 300 is shown. The inlet guide wheel 300 comprises a plurality of such guide vanes 3 that are arranged in the flow channel 5 in a manner distributed in the circumferential direction. The guide vanes 3 are for example arranged inside a housing appliance (which is not separately shown) that forms the radially outer flow channel boundary 51.

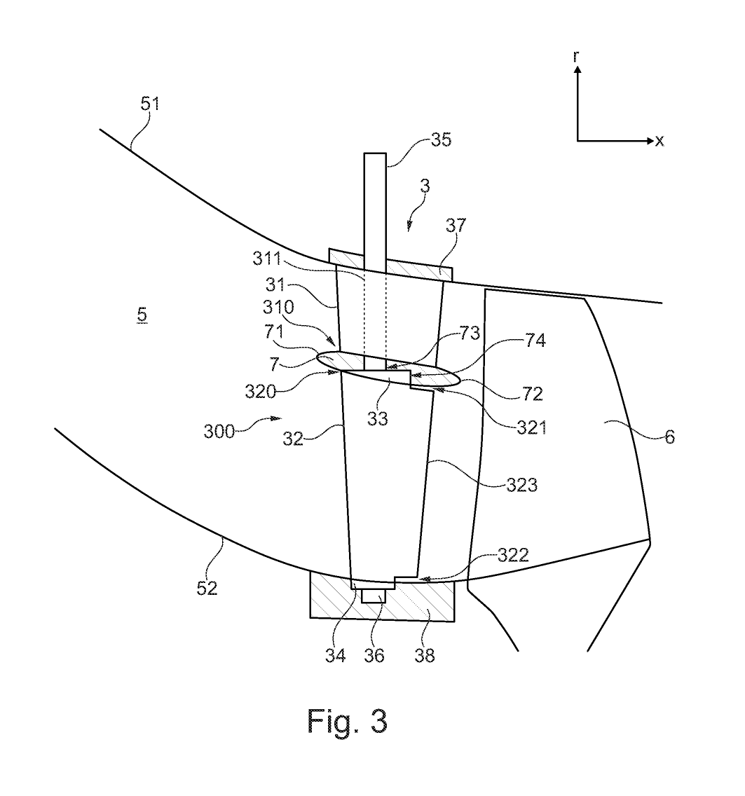

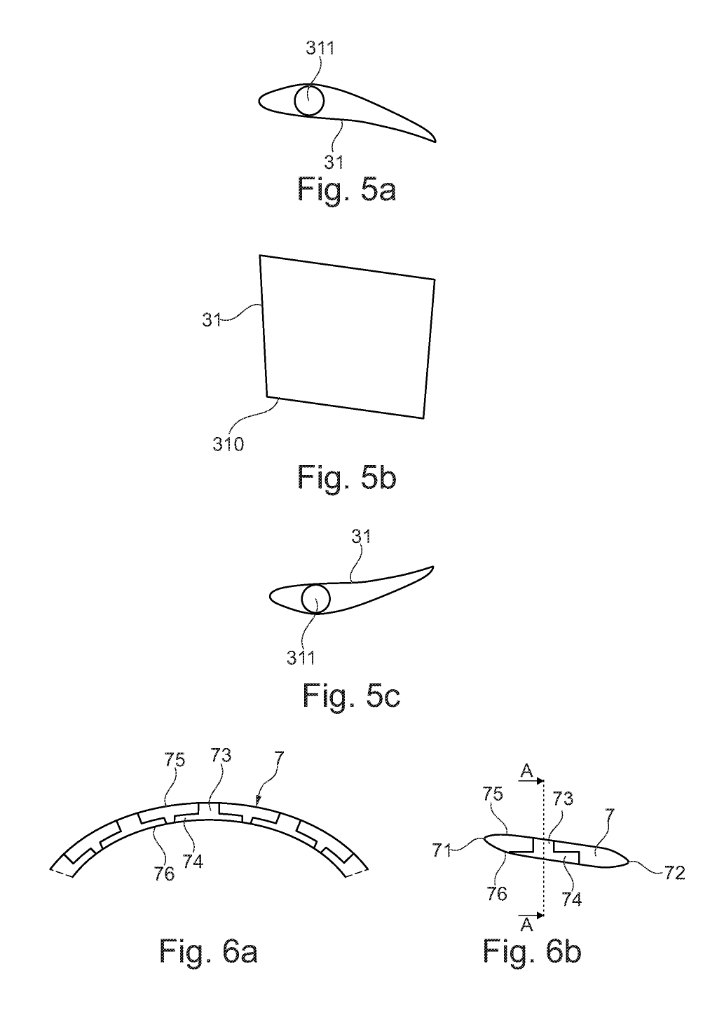

FIGS. 3, 4a-4c, 5a-5c and 6a-6b show an exemplary embodiment of an inlet guide wheel 300. According to the rendering of FIG. 2, the inlet guide wheel 300 is located inside a flow channel 5 that has a radially outer flow channel boundary 51 and a radially inner flow channel boundary 52. The inlet guide wheel 300 is located in front of the first rotor 6 of a compressor.

The inlet guide wheel 300 has a plurality of guide vanes 3 arranged inside the annular space that is formed by the flow channel 5 in a manner distributed in the circumferential direction. It comprises a housing tip shroud 37 with which it is arranged inside a housing appliance, which is not shown, in the area of the radially outer flow channel boundary 51. The inlet guide wheel 300 further comprises an inner tip shroud 38 that forms the radially inner flow channel boundary 52 in the area of the inlet guide wheel 300. Alternatively, the inlet guide wheel 300 can also be formed without an inner tip shroud 38, in which case the guide vanes 3 form a gap towards the radially inner flow channel boundary 52.

The following description of an embodiment of one of the guide vanes 3 applies to all guide vanes of the inlet guide wheel 300. The guide vane 3 extends in the flow channel 5 in the radial direction r between the housing tip shroud 37 and the inner tip shroud 38. It comprises a first, radially outer aerofoil 31 and a second, radially inner aerofoil 32.

The first, radially outer aerofoil 31 is locally affixed and cannot be adjusted with respect to its stagger angle. In contrast, the second radially inner aerofoil 32 is adjustable and can be set with respect to its stagger angle. For this purpose, it has an outer circular platform 33 that forms a rotary plate and is connected to a spindle 35 via which the stagger angle of the second aerofoil 32 can be adjusted from outside the flow channel 5. The spindle 35 is guided inside a spindle guide 311 in the first aerofoil 31. The second, radially inner aerofoil 32 further has an inner circular platform 34 that forms a further rotary plate and that is connected to an inner spindle 36 that is mounted in the inner tip shroud 38. At that, the inner platform 34 at least partially delimits the flow channel 5 in the area of the radially inner flow channel boundary 52.

The inlet guide wheel 300 further comprises a tip shroud 7 that extends in a ring-shaped manner in the flow channel 5, separating the first aerofoil 31 and the second aerofoil 32 in the radial direction. The tip shroud 7 is embodied in an aerodynamically low-drag manner and has a rounded-off leading edge 71 as well as a rounded-off trailing edge 72. It further has a radially outer top side 75 and a radially lower bottom side 76, cf. FIGS. 6a and 6b.

The tip shroud 7 is firmly connected to the first aerofoil 31 or formed in one piece with the same. For this purpose, it can be provided that the tip shroud 7 and the first aerofoil 31 are manufactured in a single manufacturing process and accordingly consist of the same material. The tip shroud 7 is thus connected in a torque-proof manner to the first aerofoil 31, and is firmly connected via the same as well as via the housing tip shroud 37 to structural components of the outer flow channel boundary 51, e.g. a housing appliance. At that, it is provided in one embodiment variant that the tip shroud 7, the first aerofoil 31 and the housing tip shroud 37 are formed in one piece.

The tip shroud 7 covers the radially inner end 310 of the first aerofoil 31 as well as the radially outer end 320 of the second aerofoil 32 ab. As can be directly seen from FIG. 3, such a cover can be realized in such a manner that, at least in the area of the leading edges of the aerofoils 31, 32, no gap is formed between the radially inner end 310 of the first aerofoil 31 and the tip shroud 7, and no gap is formed between the radially outer end 320 of the second aerofoil 32 and the tip shroud 7.

The tip shroud 7 further serves for receiving and mounting components of the second aerofoil 32. Thus, at its top side 75, the tip shroud 7 has a circular hole 73 for receiving and mounting the ends 351 of the spindle 35, cf. FIGS. 3 and 6a, 6b. Further, at its bottom side 76, it has a circular hole 74 for receiving the outer platform 33 of the second aerofoil 32. Thus, in addition to its function of avoiding any leakage and turbulences at the aerofoil ends by covering the ends 310, 320 of the aerofoils 31, 32 projecting into the flow channel 5, the tip shroud 7 also fulfills the function of receiving and mounting the bearing and adjusting elements to provide the adjustability of the second aerofoil 32.

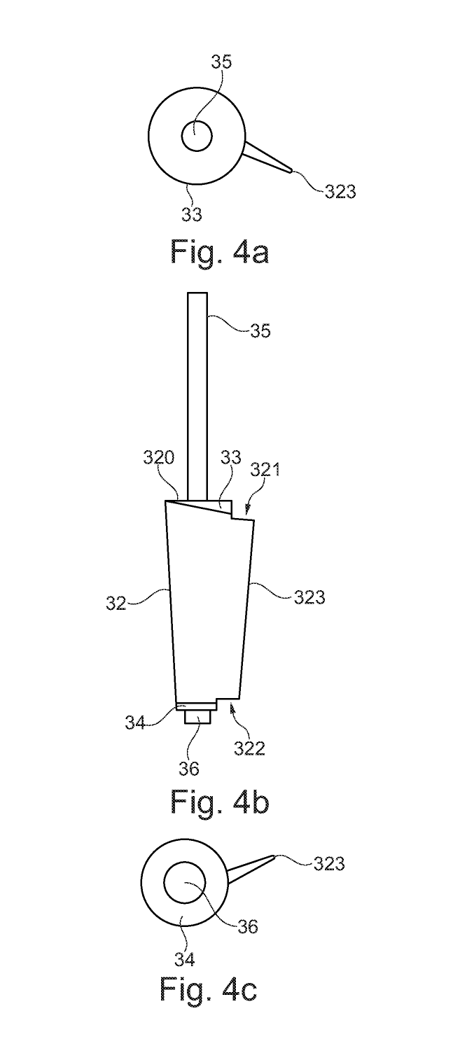

As can in particular also be seen from FIG. 4b, the second aerofoil 32 has cut backs 321, 322 in the area of its trailing edge 323 radially adjoining the tip shroud 7 and radially adjoining the radially inner flow channel boundary 52, which the cut backs 321, 322 ensuring that the second aerofoil 32 respectively forms a gap towards the tip shroud 7 and a gap towards the radially inner flow channel boundary 52 in its axially rear area, whereby it is avoided that the second aerofoil 32 collides with the inner tip shroud 7 or the radially inner flow channel boundary 52 when being adjusted.

According to FIGS. 6a and 6b, the tip shroud 7 extends inside the flow channel in a ring-shaped manner, with FIG. 6a showing a section of approximately 45° in the circumferential direction. Here, the tip shroud ring 7 can be divided into segments that are connected to each other. This also applies to the inlet guide wheel as a whole.

In alternative embodiments, it can be provided that the tip shroud 7 is not embodied as a ring, but rather by structures that are limited in the circumferential direction and that respectively divide the first aerofoil and the second aerofoil in the described manner only in one of the guide vanes or in only in some of the guide vanes.

It can be provided that the second aerofoil 32 extends in the radial direction r across a length that corresponds to at least 50%, in particular to at least 60%, in particular to at least 70%, of the total length of the radial extension of the two aerofoils 31, 32.

During operation of the compressor, in front of the first rotor 6 of which the inlet guide wheel 300 is arranged, the second aerofoils 32 are adjusted in such a manner with respect to their stagger angle at least in the partial load range that the second aerofoils 32 cause a stronger swirl to be applied to the passing work fluid than the first aerofoils 31. In this manner, it is achieved that the rotor blades of the rotor 6 arranged downstream of the inlet guide wheel 300 are impacted by the flow with a higher axial velocity in the radially outer area, whereby the danger of flow separation and vibration excitation occurring is reduced.

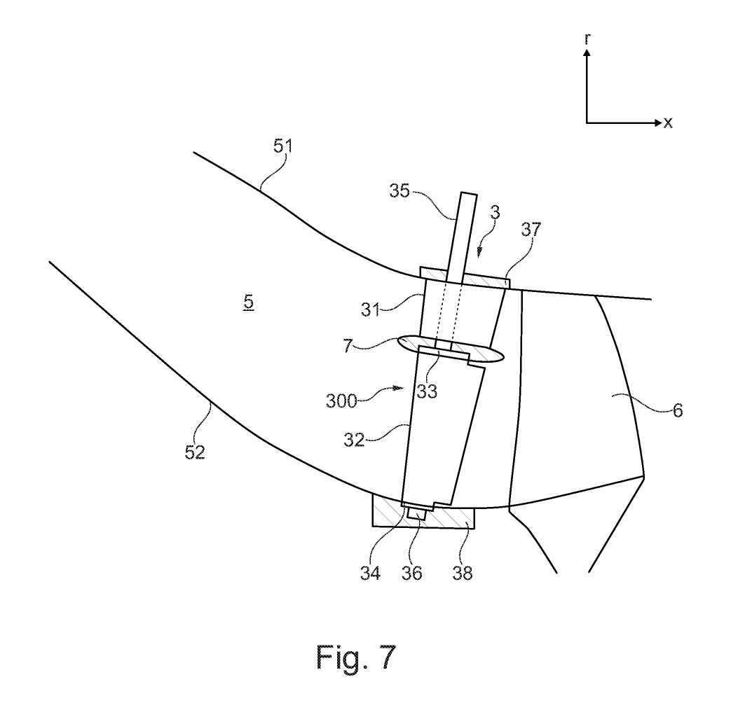

FIG. 7 shows an exemplary embodiment corresponding to the exemplary embodiment of FIGS. 3, 4a-4c, 5a-5c and 6a-6b, except for the fact that the spindle axis for adjusting a radially inner aerofoil extends in a tilted manner with respect to the radial direction r.

Thus, just like in FIG. 3, the inlet guide wheel 300 of FIG. 7 has a first, radially outer aerofoil 31, a second, radially inner aerofoil 32, and a tip shroud 7 separating the first aerofoil 31 and the second aerofoil 32. The second aerofoil 32 comprises an outer platform 33 and a spindle 35 via which the second aerofoil 32 can be adjusted with respect to its stagger angle, as well as an inner platform 34 and an inner spindle 36 that are mounted in a radially inner tip shroud 38. The tip shroud 7 is fixedly connected to the first aerofoil 31 and can be formed integrally with the same. It is attached via the first aerofoil 31 and a housing tip shroud 37 inside a housing structure that forms the radially outer flow channel boundary 51. Regarding any details of the exemplary embodiment, FIGS. 3, 4a-4c, 5a-5c and 6a-6b as well as the associated description is referred to.

In contrast to the embodiment of FIGS. 7 to 6b, the axis of the spindle 35 is tilted with respect to the radial direction r, wherein the angle between the spindle axis and the radial direction r may for example be smaller than 30°. Tilting the spindle axis can have the advantage that the outer platform 33 can be arranged and mounted inside the tip shroud 7 more completely, and that the cut backs 321 and 322 in the rear area of the second aerofoil 32 towards the tip shroud 7 and the radially inner flow channel boundary 52 can be less pronounced

In FIGS. 3 and 7 the flow channel 5 is shown with descending annulus lines upstream of the inlet guide wheel 300. However, this is to be understood merely as an example. The flow channel 5 can also have other courses and can alternatively be formed in a straight manner or with ascending annulus lines in front of the inlet guide wheel 300, for example.

It should be understood that the above description is intended for illustrative purposes only, and is not intended to limit the scope of the present disclosure in any way. For example, the exact shape and embodiment of the tip shroud 7 and its radial positioning in the flow channel 5 are to be understood merely as an example.

Thus, those skilled in the art will appreciate that other aspects of the disclosure can be obtained from a study of the drawings, the disclosure and the appended claims. All methods described herein can be performed in any suitable order unless otherwise indicated herein or otherwise clearly contradicted by context. Various features of the various embodiments disclosed herein can be combined in different combinations to create new embodiments within the scope of the present disclosure. Any ranges given herein include any and all specific values within the range and any and all sub-ranges within the given range.

What is claimed is:

1. Inlet guide wheel for a turbo engine comprising a plurality of guide vanes that radially extend inside a flow channel of the turbo engine, and that respectively comprise:
a first, radially outer aerofoil that comprises a radially inner end, and
a second, radially inner aerofoil that comprises a radially outer end,
wherein the first aerofoil and/or the second aerofoil is embodied in a rotatable manner, and wherein
the first aerofoil and the second aerofoil are separated by a tip shroud that at least partially covers both the radially inner end of the first aerofoil and the radially outer end of the second aerofoil.

2. Inlet guide wheel according to claim 1, wherein the first aerofoil is locally affixed and the second aerofoil is rotatable relative to the first aerofoil.

3. Inlet guide wheel according to claim 1 or 2, wherein the tip shroud is connected to the first aerofoil or is formed in one piece with the same.

4. Inlet guide wheel according to claim 3, wherein the tip shroud, the first aerofoil and an outer tip shroud by means of with which the first aerofoil can be arranged inside an outer housing structure are integrally formed.

5. Inlet guide wheel according to claim 1, wherein the second aerofoil is connected in a torque-proof manner to an outer spindle to be rotatable, wherein the outer spindle is guided inside a spindle passage of the first aerofoil.

6. Inlet guide wheel according to claim 5, wherein the longitudinal axis of the outer spindle extends in the radial direction.

7. Inlet guide wheel according to claim 5, wherein the longitudinal axis of the outer spindle extends in a tilted manner with respect to the radial direction.

8. Inlet guide wheel according to claim 5, wherein the outer spindle has a spindle end that projects from the first aerofoil at the inner side and that is arranged inside the tip shroud and mounted in the same.

9. Inlet guide wheel according to claim 1, wherein the second aerofoil, at its radially outer end, is connected to an outer circular platform or forms such an outer circular platform, wherein the outer platform is arranged inside the tip shroud and mounted in the same.

10. Inlet guide wheel according to claim 9, wherein the outer spindle has a spindle end that projects from the first aerofoil at the inner side and that is arranged inside the tip shroud and mounted in the same, and wherein the tip shroud has a circular hole for receiving and mounting the spindle end of the outer spindle and, radially adjoining thereto, has a circular hole for receiving and mounting the outer platform.

11. Inlet guide wheel according to claim 9, wherein the second aerofoil, at its radially inner end, is connected to an inner circular platform and the latter is connected to an inner spindle, wherein the inner spindle is arranged and mounted inside an inner tip shroud of the inlet guide wheel.

12. Inlet guide wheel according to claim 1, wherein the tip shroud covers the radially inner end of the first aerofoil and the radially outer end of the second aerofoil in such a manner that no gap is formed between the radially inner end of the first aerofoil and the tip shroud, and no gap is formed between the radially outer end of the second aerofoil and the tip shroud at least in the area of the leading edges of the aerofoils.

13. Inlet guide wheel according to claim 1, wherein, in the area of its trailing edge adjoining the tip shroud, the second aerofoil has a cut back in such a manner that it forms a gap towards the tip shroud in the area of its trailing edge.

14. Inlet guide wheel according to claim 1, wherein in the area of its trailing edge adjoining the radially inner flow channel boundary, the second aerofoil has a cut back in such a manner that it forms a gap towards a radially inner flow channel boundary in the area of its trailing edge.

15. Inlet guide wheel according to claim 1, wherein the first aerofoils and the second aerofoils are formed in such a manner and the second aerofoils can be adjusted in the partial load range in such a manner with respect to the stagger angle that the second aerofoils cause a stronger swirl to be applied to a passing work fluid than the first aerofoils.

16. Inlet guide wheel according to claim 1, wherein the second aerofoils extend in the radial direction across a length that corresponds to at least 50%, in particular to at least 60%, in particular to at least 70%, of the total length of the radial extension of the first and second aerofoils.

17. Inlet guide wheel according to claim 1, wherein the tip shroud forms a rounded-off leading edge and a rounded-off trailing edge.

18. Inlet guide wheel according to claim 1, wherein the tip shroud is formed as a tip shroud ring that separates the first aerofoil and the second aerofoil in all guide vanes of the inlet guide wheel.

19. Inlet guide wheel for a turbo engine comprising a plurality of guide vanes that radially extend inside a flow channel of the turbo engine, and that respectively comprise:
a first, radially outer aerofoil that comprises a radially inner end, and
a second, radially inner aerofoil that comprises a radially outer end, wherein
the first aerofoil and the second aerofoil are separated by a tip shroud which at least partially covers both the radially inner end of the first aerofoil and the radially outer end of the second aerofoil,
the first aerofoil is locally affixed and the second aerofoil is rotatable relative to the first aerofoil,
the second aerofoil is connected in a torque-proof manner to an outer spindle for the purpose of providing rotatability, wherein the outer spindle is guided inside a spindle passage of the first aerofoil, and
the second aerofoil, at its radially outer end, is connected to an outer circular platform or forms such an outer circular platform, wherein the outer platform is arranged inside the tip shroud and is mounted in the same.

20. Turbo engine with an inlet guide wheel according to claim 1, wherein the inlet guide wheel is arranged upstream of the first rotor of the turbo engine.
